(19) United States
(12) Patent Application Publication
(10) Pub. No.: US 2017/0064103 A1
(43) Pub. Date: Mar. 2, 2017

(54) Image Processing Apparatus, Display Control Method and Non-Transitory Computer-Readable Recording Medium Encoded with Display Control Program

(71) Applicant: Konica Minolta, Inc., Tokyo (JP)

(72) Inventors: Hiroyuki OHNO, Toyokawa-shi (JP); Jun SHIRAISHI, Toyokawa-shi (JP); Hideyuki MATSUDA, Hirakata-shi (JP); Yoichi KURUMASA, Toyokawa-shi (JP); Mie KAWABATA, Toyokawa-shi (JP)

(73) Assignee: Konica Minolta, Inc., Tokyo (JP)

(21) Appl. No.: 15/245,355

(22) Filed: Aug. 24, 2016

(30) Foreign Application Priority Data
Aug. 31, 2015 (JP) 2015-170729

(51) Int. Cl. H04N 1/00

(52) U.S. Cl. CPC H04N 1/00419; H04N 1/00411; H04N 2201/0094

(57) ABSTRACT

An image processing apparatus displays any one of a plurality of operation screens, which are respectively associated with at least one of other operation screens and for accepting a setting value for execution of at least one of the plurality of processes, in the display, selects one or more sub-screens among a plurality of sub-screens not associated with an operation screen displayed in the display based on a state of a process executed by the hardware processor and/or the displayed operation screen, displays one or more instruction keys respectively associated with the one or more selected sub-screens in the display simultaneously with the operation screen displayed in the display, and in response to designation of any of the one or more instruction keys displayed in the display by a user, displays a sub-screen associated with the designated instruction key among the one or more selected sub-screens in the display.

### CROSS-REFERENCE TO RELATED APPLICATIONS

This application is entitled to and claims the benefit of Japanese Patent Application No. 2015-170729 filed with Japan Patent Office on Aug. 31, 2015, the entire contents of which are hereby incorporated by reference.

### BACKGROUND OF THE INVENTION

Field of the Invention

The present invention relates to an image processing apparatus, a display control method and a non-transitory computer-readable recording medium encoded with a display control program. More specifically, the present invention relates to an image processing apparatus that displays an operation screen for accepting a setting value for execution of a process, a display control method performed in the image processing apparatus, and a non-transitory computer-readable recording medium encoded with a display control program.

Description of the Related Art

An imaging processing apparatus such as an Multi Function Peripheral (MFP) displays an operation screen that accepts setting of a setting value in order to execute a process such as copying, and executes a process in accordance with the setting value that is input by a user in accordance with the operation screen. The operation screen is associated with another operation screen and includes a transition key for switching the display to the other associated operation screen such that the user can display a desired operation screen. The user can allow the desired operation screen to be displayed by inputting an operation of designating the transition key. The number of operation screens has increased due to the increased variety of functions of the MFP, and the user is required to perform an operation of switching the display to an appropriate operation screen. On the one hand, a screen that is common among a plurality of operation screens is sometimes present. For example, the screen includes a screen of a keyboard for setting a setting value in an operation screen, and a screen that displays information for reference in order for the user to input a setting value in accordance with an operation screen. In this case, in the case where the number of screens that are common among a plurality of operation screens is large, a plurality of transition keys for respectively making a transition to the plurality of screens that are common among the plurality of operation screens must be respectively arranged in the operation screens.

For example, in Japanese Patent Laid-Open No. 2012-103602, an image forming apparatus having an operation panel for performing screen display includes a screen display processing portion that allows a first screen to be displayed in the operation panel, a slide-in display processing portion that allows, in response to an operation on the operation panel, a second screen having a plurality of operation keys arranged at different positions in a sliding direction from one end to another end of a display screen to slide on the first screen to move in the sliding direction, a slide-in controller that stops the sliding movement when a change in state that corresponds to a predetermined stop condition occurs during the sliding movement of the second screen, and an input processing portion that accepts an operation by an operation key being displayed with at least one of the plurality of operation keys being displayed.

However, when the number of a plurality of screens that are common among a plurality of operation screen is increased, there is a problem that the number of a plurality of keys for displaying the plurality of screens is increased. There also is a problem with the image forming apparatus described in Japanese Patent Laid-Open No. 2012-103602 that the number of the plurality of operation keys arranged in the second screen is increased.

### SUMMARY OF THE INVENTION

According to one aspect of the present invention, an image processing apparatus includes a display capable of displaying an image, a hardware processor capable of executing at least one of a plurality of processes, wherein the hardware processor displays any one of a plurality of operation screens, which are respectively associated with at least one of other operation screens and for accepting a setting value for execution of at least one of the plurality of processes, in the display, selects one or more sub-screens among a plurality of sub-screens not associated with an operation screen displayed in the display based on a state of a process executed by the hardware processor and/or the displayed operation screen, displays one or more instruction keys respectively associated with the one or more selected sub-screens in the display simultaneously with the operation screen displayed in the display, and in response to designation of any of the one or more instruction keys displayed in the display by a user, displays a sub-screen associated with the designated instruction key among the one or more selected sub-screens in the display.

According to another aspect of the present invention, a display control method performed by an image processing apparatus that includes a display capable of displaying an image, and a hardware processor capable of executing at least one of a plurality of processes, wherein the display control method causes the hardware processor to execute an operation screen display control step of displaying any one of a plurality of operation screens, which are respectively associated with at least one of other operation screens and for accepting a setting value for execution of at least one of the plurality of processes by the hardware processor, in the display, a sub-screen selection step of selecting one or more sub-screens among a plurality of sub-screens not associated with an operation screen displayed in the display based on a state of a process executed by the hardware processor or the displayed operation screen, an instruction key display control step of displaying one or more instruction keys respectively associated with the one or more selected sub-screens in the display simultaneously with an operation screen displayed in the display, and a sub-screen display control step of, in response to designation of any of the one or more instruction keys displayed in the display by a user, displaying a sub-screen associated with the designated instruction key among the one or more selected sub-screens in the display.

According to yet another aspect of the present invention, a non-transitory computer-readable recording medium encoded with a display control program executed by a computer controlling an image forming apparatus, the image forming apparatus comprising a display capable of displaying an image, wherein the display control program causes the computer to execute a process execution step of executing at least one of a plurality of processes, an operation screen display control step of displaying any one of a plurality of operation screens, which are respectively associated with at least one of other operation screens and for accepting a setting value for execution of at least one of the plurality of processes in the process execution step, in the display, a sub-screen selection step of selecting one or more sub-screens among a plurality of sub-screens not associated with an operation screen displayed in the display based on a state of a process executed in the process execution step or the displayed operation screen, an instruction key display control step of displaying one or more instruction keys respectively associated with the one or more selected sub-screens in the display simultaneously with an operation screen displayed in the display, and a sub-screen display control step of, in response to designation of any of the one or more instruction keys displayed in the display by a user, displaying a sub-screen associated with the designated instruction key among the one or more selected sub-screens in the display.

The foregoing and other features, aspects, and advantages of the present invention will become more apparent from the following detailed description of the present invention when taken in conjunction with the accompanying drawings.

### BRIEF DESCRIPTION OF THE DRAWINGS

FIG. 1 is a perspective view showing an appearance of an MFP in one embodiment of the present invention;

FIG. 2 is a block diagram showing an outline of a hardware configuration of the MFP;

FIG. 3 is a plan view of an operation panel;

FIG. 4 is a block diagram showing one example of functions of a CPU included in the MFP in the present embodiment;

FIG. 5 is a diagram showing one example of a screen displayed in a display unit;

FIG. 6 is a diagram showing one example of a sub-screen of a job list;

FIG. 7 is a diagram showing one example of a sub-screen of a numeric keyboard;

FIG. 8 is a diagram showing one example of a sub-screen for problem notification;

FIG. 9 is a diagram showing one example of a sub-screen for procedure notification;

FIG. 10 is a diagram showing one example of a sub-screen for consumables;

FIG. 11 is a diagram showing one example of a sub-screen of a keyboard with a radix point;

FIG. 12 is a diagram showing one example of a sub-screen of an English-numeric keyboard;

FIG. 13 is a diagram showing one example of a sub-screen for requesting repair;

FIG. 14 is a flow chart showing one example of a flow of a display control process; and

FIG. 15 is a flow chart showing one example of a flow of a sub-screen selection process.

### DESCRIPTION OF THE PREFERRED EMBODIMENTS

The preferred embodiments of the present invention will be described below with reference to drawings. In the following description, the same parts are denoted with the same reference characters. Their names and functions are also the same. Thus, a detailed description thereof will not be repeated.

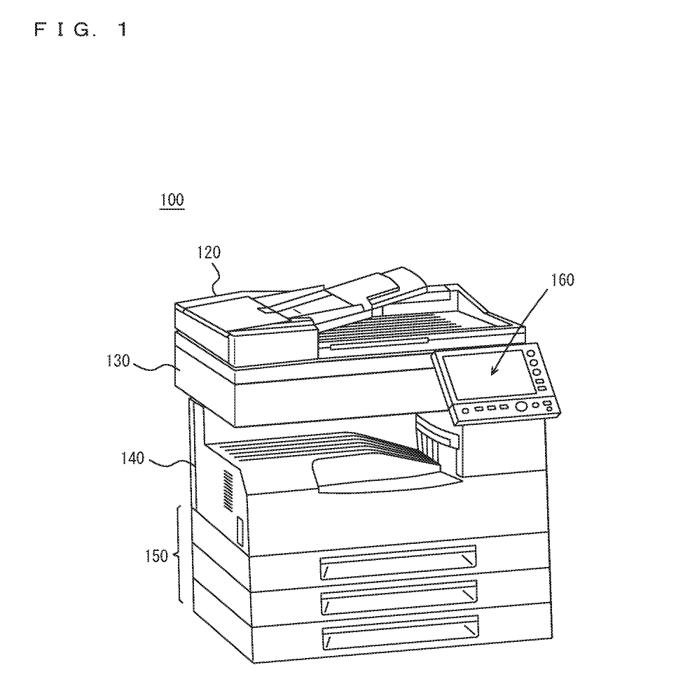

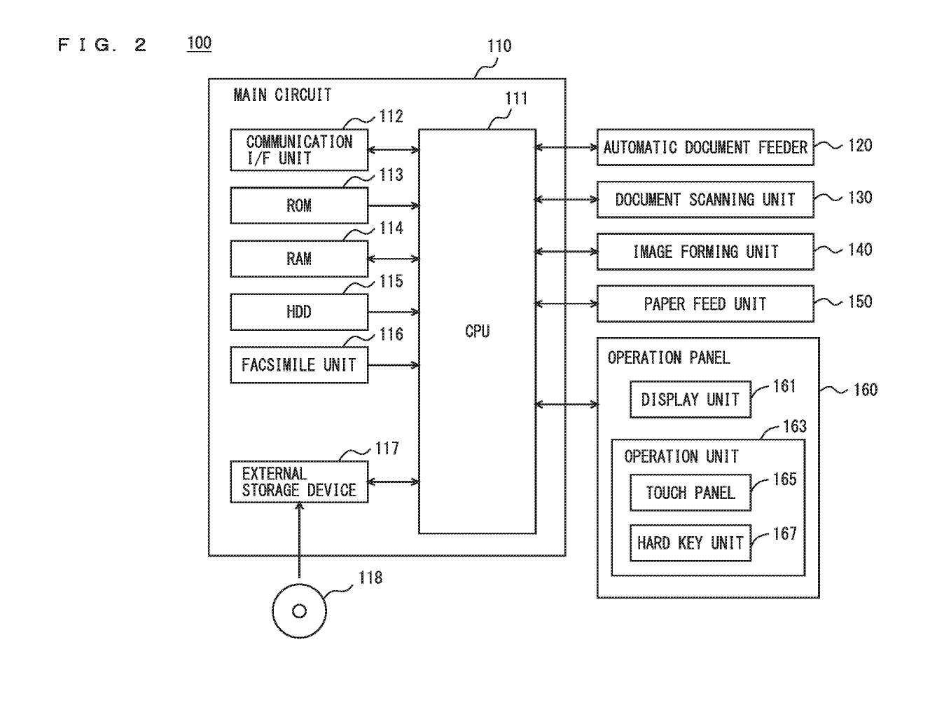

FIG. 1 is a perspective view showing an appearance of an MFP in one embodiment of the present invention. FIG. 2 is a block diagram showing an outline of a hardware configuration of the MFP. Referring to FIGS. 1 and 2, the MFP 100 that functions as an image processing apparatus includes a main circuit 110, a document scanning unit 130 for scanning a document, an automatic document feeder 120 for conveying a document to the document scanning unit 130, an image forming unit 140 for forming an image on paper or other medium based on image data output by the document scanning unit 130 scanning a document, a paper feed unit 150 for supplying paper to the image forming unit 140, and an operation panel 160 serving as a user interface.

The main circuit 110 includes a CPU 111 that controls the entire MFP 100, a communication interface (I/F) unit 112, a ROM 113, a RAM 114, and a hard disk drive (HDD) 115 used as a mass storage device, a facsimile unit 116, and an external storage device 117. The CPU 111 is connected to the automatic document feeder 120, the document scanning unit 130, the image forming unit 140, the paper feed unit 150, and the operation panel 160, and controls the entire MFP 100.

The automatic document feeder 120 automatically transports a plurality of documents set on a document feed tray to a predetermined document scanning position set on a platen glass of the document scanning unit 130 one by one, and discharges the document of which a document image is scanned by the document scanning unit 130 to a document discharge tray. The document scanning unit 130 includes a light source that irradiates the document transported to the document scanning position with light, and an optoelectronic transducer that receives the light reflected by the document, and scans the document image according to a size of the document. The optoelectronic transducer converts the received light into image data, which is an electric signal, and outputs the image data to the image forming unit 140. The paper feed unit 150 transports the paper stored in the paper feed tray to the image forming unit 140.

The image forming unit 140 forms an image by a well-known electrophotographic method, and forms an image on the paper transported by the paper feed unit 150 based on image data on which a data process is performed or image data that is externally received. The data process includes various data processes such as shading correction performed on the image data received from the document scanning unit 130.

The facsimile unit 116 is connected to a Public Switched Telephone Network (PSTN) to transmit facsimile data to the PSTN or receive facsimile data from the PSTN. The facsimile unit 116 stores the received facsimile data in the HDD 115, and converts the received facsimile data into print data that can be printed by the image forming unit 140 to output the print data to the image forming unit 140. Thus, the image forming unit 140 prints the facsimile data received from the facsimile unit 116 on paper. Further, the facsimile unit 116 converts the data stored in the HDD 115 into facsimile data and transmits the converted facsimile data to a facsimile machine connected to the PSTN.

The communication I/F unit 112 is an interface for connecting the MFP 100 to a network. The communication I/F unit 112 communicates with another computer or a data processing apparatus connected to the network with a communication protocol such as TCP (Transmission Control Protocol) or FTP (File Transfer Protocol). The network to which communication I/F unit 112 is connected is a Local Area Network (LAN), either wired or wireless. The network is not limited to a LAN and may be a Wide Area Network (WAN), a PSTN, or the internet.

The ROM 113 stores a program executed by the CPU 111 or data necessary to execute the program. The RAM 114 is used as a working area when the CPU 111 executes a program. Further, the RAM 114 temporarily stores scan images successively sent from the document scanning unit 130.

The operation panel 160 is provided on an upper surface of the MFP 100. The operation panel 160 includes a display unit 161 and an operation unit 163. The display unit 161 is a Liquid Crystal Display (LCD), for example, and displays an instruction menu for a user, information about acquired image data and the like. The LCD 165 can be replaced with any other device that displays an image, for example, an organic EL (Electroluminescence) display.

The operation unit 163 includes a touch panel 165 and a hard key unit 167. The touch panel 165 is a capacitance type. The touch panel 165 is not limited to the capacitance type, and another type such as a resistive film type, a surface acoustic wave type, an infrared type, and an electromagnetic induction type, for example, can be used.

The touch panel 165 is provided with its detection surface being superimposed on an upper surface or a lower surface of the display unit 161. The size of the detection surface of the touch panel 165 and the size of the display surface of the display unit 161 are the same. Therefore, the coordinate system of the display surface and the coordinate system of the detection surface are the same. The touch panel 165 detects a position designated by the user on the display surface of the display unit 161, and outputs a set of coordinates of the detected position to the CPU 111. Because the coordinate system of the display surface and the coordinate system of the detection surface are the same, the set of coordinates output by the touch panel 165 can be replaced with the set of coordinates of the display surface. Hereinafter, the set of coordinates, which are detected on the detection surface and output by the touch panel 165 when the user gives a designation on the display surface of the display unit 161, are also referred to as the set of coordinates of the display surface.

The hard key unit 167 includes a plurality of hard keys. The hard keys are contact switches, for example. The touch panel 165 detects a position designated by the user on the display surface of the display unit 161. In the case where operating the MFP 100, the user is likely to be in an upright attitude, so that the display surface of the display unit 161, an operation surface of the touch panel 165, and the hard key unit 167 are arranged to face upward. This is for the purpose of enabling the user to easily view the display surface of the display unit 161 and easily give an instruction on the operation unit 163 with his or her finger.

The external storage device 117 is controlled by the CPU 111. A CD-ROM (Compact Disk Read Only Memory) 118 or a semiconductor memory is mounted on the external storage device 117. While an example where the CPU 111 executes a program stored in the ROM 113 is described in the present embodiment, the CPU 111 may control the external storage device 117 to read a program to be executed by the CPU 111 from the CD-ROM 118 and store the read program in the RAM 102 for execution.

A recording medium for storing a program to be executed by the CPU 111 is not limited to the CD-ROM 118 but may be a flexible disk, a cassette tape, an optical disk (MO (Magnetic Optical Disc)/MD (Mini Disc)/DVD (Digital Versatile Disc)), an IC card, an optical card, or a semiconductor memory such as a mask ROM, an EPROM (Erasable Programmable ROM), or an EEPROM (Electrically EPROM). The CPU 111 may download a program from a computer connected to the network and store the downloaded program in the HDD 115, or the computer connected to the network may write the program in the HDD 115, so that the program stored in the HDD 115 is loaded in the RAM 114 and executed by the CPU 111. The program referred to here includes not only a program directly executable by the CPU 111 but also a source program, a compressed program, an encrypted program and the like.

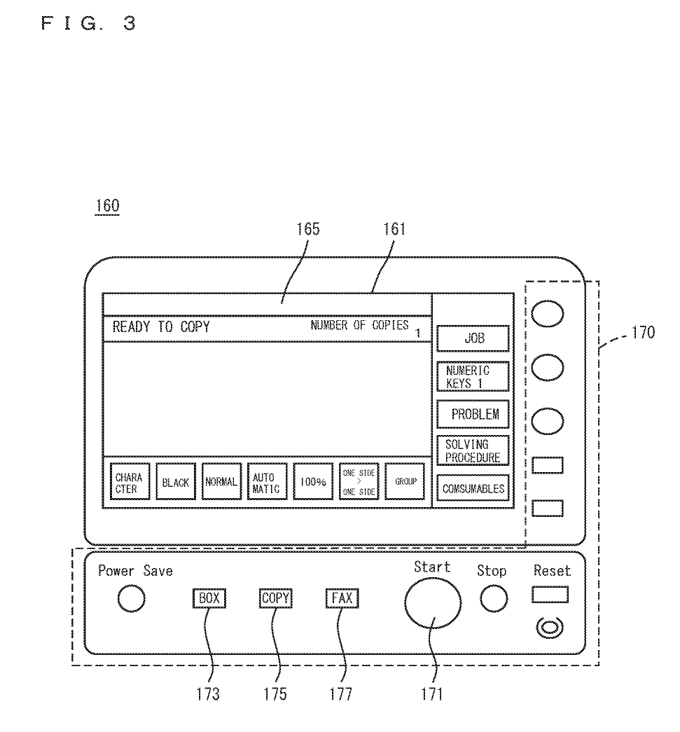

FIG. 3 is a plan view of the operation panel 160. Referring to FIG. 3, the operation panel 160 includes the display unit 161 and the touch panel 165 superimposed on the display unit 161, and the hard key unit 167, in which the plurality of hard keys including a start key 171, a BOX key 173, a COPY key 175 and a FAX key 177 are arranged, on the right side and below the display unit 161.

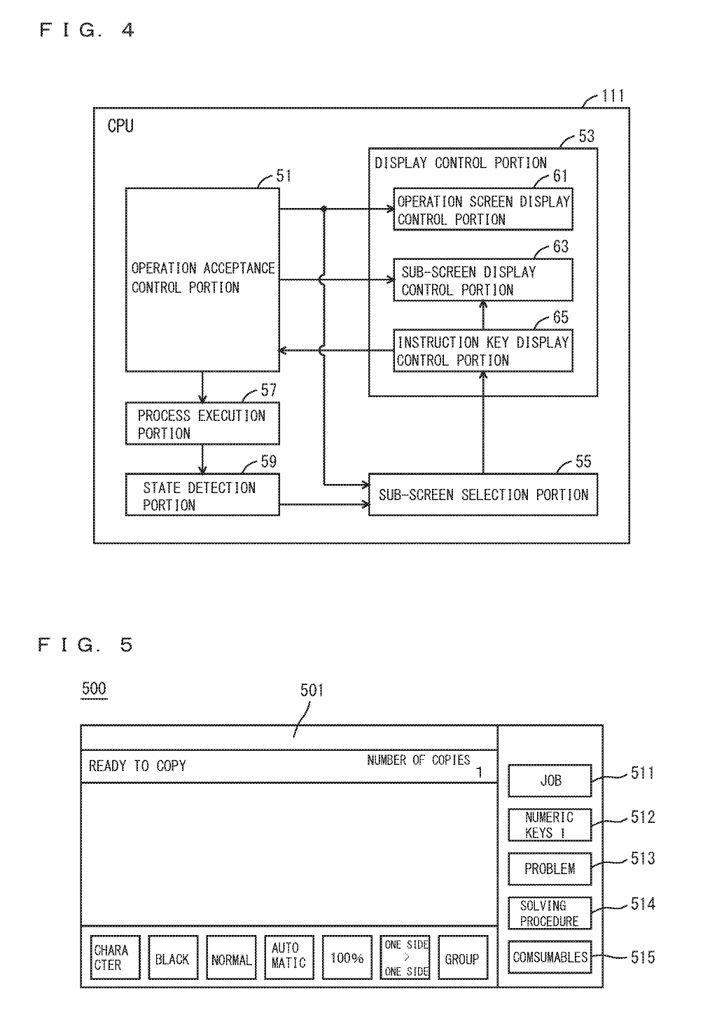

FIG. 4 is a block diagram showing one example of functions of the CPU included in the MFP in the present embodiment. The functions shown in FIG. 4 are formed by the CPU 111 when the CPU 111 included in the MFP 100 executes a display control program stored in the ROM 113, the HDD 115 or the CD-ROM 118. Referring to FIG. 4, the CPU 111 includes an operation acceptance control portion 51, a display control portion 53 that controls the display unit 161, a sub-screen selection portion 55, a process execution portion 57, and a state detection portion 59.

The operation acceptance control portion 51 gives an instruction to the display control portion 53 to display an operation screen for accepting an operation by the user, and determines an operation that is input by the user in accordance with the operation screen in the operation unit 163. Specifically, the operation acceptance control portion 51 outputs a display instruction including screen identification information for identifying the operation screen to the display control portion 53, and outputs the screen identification information to the sub-screen selection portion 55. In an initial stage, the operation acceptance control portion 51 outputs the display instruction including the screen identification information of the predetermined operation screen to the display control portion 53, and outputs the screen identification information to the sub-screen selection portion 55. The initial stage includes the time when power is applied to the MFP 100, or the time when the MFP 100 is recovered from a sleep state where power consumption is low, for example.

The display control portion 53 includes an operation screen display control portion 61, a sub-screen display control portion 63, and an instruction key display control portion 65. In response to reception of the display instruction from the operation acceptance control portion 51, the operation screen display control portion 61 reads the operation screen specified by the screen identification information included in the display instruction, and displays the read operation screen in the display unit 161.

The operation acceptance control portion 51 controls the touch panel 165. In response to reception of the set of coordinates from the touch panel 165 after outputting the screen identification information to the display control portion 53, the operation acceptance control portion 51 determines an operation by the user based on the set of coordinates received from the touch panel 165. The operation acceptance control portion 51 specifies the position designated by the user in the operation screen based on the set of coordinates received from the touch panel 165. Specifically, the operation acceptance control portion 51 determines an operation by converting the position specified by the set of coordinates received from the touch panel 165 in the image of the operation screen displayed in the display unit 161 into the position in the operation screen designated by the user.

The operation acceptance control portion 51 determines an operation corresponding to the position specified in the operation screen. For example, in the case where the operation screen includes an execution instruction button to which an operation of giving an instruction to execute a process is assigned, if the position designated by the user in the operation screen is in a range of the execution instruction button, the operation acceptance control portion 51 specifies an execution instruction operation. In the case where specifying the execution instruction operation, the operation acceptance control portion 51 outputs an execution instruction to the process execution portion 57. The execution instruction includes process identification information for identifying the process assigned to the execution instruction operation.

Further, in the case where the position designated by the user in the operation screen is a region that displays a setting value included in the operation screen, and also a setting value is input afterwards, the operation acceptance control portion 51 determines an operation of setting a setting value. In the case where determining the operation of setting a setting value, the operation acceptance control portion 51 outputs a setting instruction to the process execution portion 57. The setting instruction includes setting value identification information for identifying a setting value, and a setting value.

Further, in the case where the operation screen includes a transition button to which another operation screen is assigned, if the position designated by the user in the operation screen is in a range of the transition button, the operation acceptance control portion 51 specifies an operation of making a transition of the screen. In the case where specifying the operation of making a transition of the screen, the operation acceptance control portion 51 outputs a display instruction including the screen identification information of the operation screen assigned to the transition button to the display control portion 53.

In response to reception of the setting instruction from the operation acceptance control portion 51, the process execution portion 57 sets a setting value in accordance with the setting instruction. In response to reception of the execution instruction from the operation acceptance control portion 51, the process execution portion 57 executes the process corresponding to the process specified by the process identification information included in the execution instruction in accordance with the setting value being set at the time point. The process execution portion 57 controls hardware resources and executes the process. The hardware resources include the communication I/F unit 112, the facsimile unit 116, the HDD 115, the external storage device 117, the automatic document feeder 120, the document scanning unit 130, the image forming unit 140, and the paper feed unit 150.

One example of a process executed by the process execution portion 57 includes a scanning process, a copying process, a printing process, a facsimile transmitting receiving process and the like. The scanning process is a process of outputting an image of the document scanned by the document scanning unit 130 to at least one of the HDD 115, the external storage device 117, and the communication I/F unit 112. The copying process is a process of forming an image of the document scanned by the document scanning unit 130 on the paper supplied from the paper feed unit 150 to the image forming unit 140. The printing process is a process of forming an image of the print data received from a computer connected to the network via the communication I/F unit 112 or an image of the data stored in the HDD 115 or the external storage device 117 on the paper supplied from the paper feed unit 150 to the image forming unit 140. The facsimile transmitting process is a process of transmitting an image of the facsimile data to the facsimile unit 116. The facsimile receiving process is a process of outputting an image of externally received facsimile data to at least one of the image forming unit 140, the HDD 115, the external storage device 117, and the communication I/F unit 112.

The state detection portion 59 detects a state of the process execution portion 57. The state of the process execution portion 57 includes a state of the process (hereinafter also referred to as a job) executed by the process execution portion 57 and states of the hardware resources controlled by the process execution portion 57. The state detection portion 59 outputs the detected state of the process execution portion 57 to the sub-screen selection portion 55. The state of the process executed by the process execution portion 57 includes whether a process is under execution by the process execution portion 57, what the process is if the process is under execution, presence or absence of a process reserved to be executed in the future by the process execution portion 57, what the process is in the case where the process is reserved, and a setting value set for execution of the process. The states of the hardware resources controlled by the process execution portion 57 include presence or absence of a problem with the hardware resources, a description of the problem in the case where there is a problem, and states of consumables of the hardware resources. The states of consumables include remaining amounts and a ratio of a period of use to a durable period.

The sub-screen selection portion 55 receives the screen identification information from the operation acceptance control portion 51, and receives the state of the process execution portion 57 from the state detection portion 59. In response to reception of the screen identification information, the sub-screen selection portion 55 selects one or more sub-screens from a plurality of predetermined sub-screens based on the operation screen specified by the screen identification information or the state of the process execution portion 57. The sub-screen selection portion 55 outputs sub-screen identification information for identifying the selected sub-screen to the instruction key display control portion 65. The sub-screen is a predetermined screen. The sub-screen includes a sub-screen not associated with any one of the plurality of operation screens and a sub-screen associated with any one of the plurality of operation screens. The operation screen with which the sub-screen is associated includes a transition key that associates the associated operation screen with the sub-screen. The sub-screen selection portion 55 selects one or more sub-screens from one or more sub-screens not associated with the operation screen specified by the screen identification information received from the operation acceptance control portion 51 among the plurality of sub-screens. In other words, the sub-screen selection portion 55 selects sub-screens not associated with the operation screen displayed in the display unit 161 among the plurality of sub-screens. This is because the sub-screen associated with the operation screen displayed in the display unit 161 is displayed by an operation of designating the transition key included in the operation screen.

The sub-screen selection portion 55 selects a sub-screen for input of a setting value from among the plurality of sub-screens. Specifically, the sub-screen selection portion 55 selects a sub-screen for input of a setting value displayed in a region that displays a setting value included in the operation screen specified by the screen identification information received from the operation acceptance control portion 51. The plurality of sub-screens include a plurality of sub-screens for input of setting values. The sub-screen for input of a setting value includes a numeric keyboard, a keyboard with a radix point, an English keyboard, and an English-numeric keyboard. The numeric keyboard is a sub-screen including images of numerals from 0 to 9, the keyboard with a radix point is a sub-screen including the images of numerals from 0 to 9 and an image of the radix point “. ”, the English keyboard is a sub-screen including images of the alphabet, and the English-numeric keyboard is a sub-screen including the images of the alphabet, the images of numerals from 0 to 9, and the image of a radix point. The sub-screen selection portion 55 selects one of the plurality of sub-screens for input of a setting value based on an attribute of the setting value that can be input in a region that displays a setting value included in the operation screen specified by the screen identification information. Specifically, in the case where an attribute of the setting value indicates only numerals, the sub-screen selection portion 55 selects the sub-screen of the numeric keyboard. In the case where an attribute of the setting value indicates numerals including a radix point, the sub-screen selection portion 55 selects the sub-screen of the keyboard with a radix point. In the case where an attribute of the setting value indicates only English letters, the sub-screen selection portion 55 selects the English keyboard. In the case where an attribute of the setting value indicates a combination of English letters and numerals, the sub-screen selection portion 55 selects the English-numeric keyboard.

In the case where a plurality of regions that display setting values in the operation screen are included, the sub-screen selection portion 55 may select the sub-screen for input of a setting value for every plurality of regions, or may select one sub-screen for the plurality of regions. For example, in the case where the operation screen includes a region that displays a setting value composed of numerals and a region that displays a setting value composed of English letters, the numeric keyboard and the English keyboard may be selected, or only the English-numeric keyboard may be selected.

The sub-screen selection portion 55 selects a sub-screen that notifies the user of the state of the process execution portion 57 from among the plurality of sub-screens based on the state of the process execution portion 57 received from the state detection portion 59. The sub-screen that notifies the user of the state of the process execution portion 57 includes a sub-screen of a job list for notifying the user of the process under execution by the process execution portion 57 and the reserved process, a sub-screen for notifying the user of the states of the hardware resources, and a sub-screen for assisting the user with a problem with the hardware resources.

In the case where the process is under execution by the process execution portion 57, the sub-screen selection portion 55 selects the sub-screen of the job list. The sub-screen of the job list is a screen that lists process identification information for identifying one or more processes under execution, and the respective reserved processes in the case where reserved processes are present.

The sub-screen selection portion 55 selects a sub-screen for notifying the user of the states of the hardware resources used for execution of the process corresponding to the operation screen. The operation screen includes a region that displays a setting value, and the setting value set in the region is used for execution of the process by the process execution portion 57. Therefore, the operation screen corresponds to any one of a plurality of processes executable by the process execution portion 57. Because the process execution portion 57 controls the hardware resources to execute the process, the hardware resources are determined for the process executed by the process execution portion 57. The sub-screen selection portion 55 specifies a process corresponding to the operation screen specified by the screen identification information received from the operation acceptance control portion 51, and selects a sub-screen that makes notification of the states of the hardware resources corresponding to the specified process. In the case where there is a problem with the hardware resources corresponding to the operation screen, the sub-screen selection portion 55 selects a sub-screen for problem notification that makes notification of the state of the problem. The sub-screen selection 55 selects a sub-screen for consumables that makes notification of the states of the consumables of the hardware resources.

The sub-screen selection portion 55 includes a sub-screen for assisting the user with the problem with the hardware resources. In the case where there is a problem with the hardware resources, the sub-screen selection portion 55 selects the sub-screen for assisting the user with the problem. The sub-screen for assisting the user includes a sub-screen for procedure notification that describes the procedure to resolve the problem with the hardware resources, and includes, in the case where the user cannot resolve the problem with the hardware resources, a sub-screen for requesting repair that shows the contact number of a repairer.

The sub-screen selection portion 55 outputs one or more sub-screen identification information for respectively identifying one or more sub-screens selected from among the plurality of sub-screens to the instruction key display control portion 65.

In response to reception of the one or more sub-screen identification information from the sub-screen selection portion 55, the instruction key display control portion 65 displays one or more instruction keys respectively corresponding to the one or more sub-screen identification information in the display unit 161. Because the operation screen is displayed in the display unit 161 by the operation screen display control portion 61, the one or more instruction keys are simultaneously displayed with the operation screen. The instruction keys may be arranged next to the operation screen, the instruction keys may be superimposed on the operation screen, or the one or more instruction keys may be superimposed on the operation screen by a predetermined operation such as designation of a predetermined region in the operation screen.

In response to display of the one or more instruction keys, the instruction key display control portion 65 outputs a set of instruction key identification information for identifying the instruction key and position information of the instruction key positioned in the display screen of the display unit 161 to the operation acceptance control portion 51 for every one or more instruction keys. Further, the instruction key display control portion 65 outputs a set of the instruction key identification information and the sub-screen identification information to the sub-screen display control portion 63 for every one or more instruction keys.

After receiving one or more sets of the instruction key identification information and the position information from the instruction key display control portion 65, the operation acceptance control portion 51 determines an operation of designating an instruction key based on the set of coordinates received from the touch panel 105. Specifically, if a position in the display screen specified by the set of coordinates received from the touch panel 165 is within any one of one or more regions specified by the one or more position information, the operation acceptance control portion 51 determines an operation of designating the instruction key. The operation acceptance control portion 51 specifies a region that includes the position specified by the set of coordinates received from the touch panel 165 among the one or more regions specified by the one or more position information, and specifies the instruction key identification information making a pair with the position information of the specified region. In the case where specifying the instruction key identification information, the operation acceptance control portion 51 outputs the specified instruction key identification information to the sub-screen display control portion 63.

The sub-screen display control portion 63 receives one or more sets of the instruction key identification information and the sub-screen identification information from the instruction key display control portion 65. In response to reception of the instruction key identification information from the operation acceptance control portion 51, the sub-screen display control portion 63 displays the sub-screen specified by the sub-screen identification information making a pair with the instruction key identification information in the display unit 161. Because the operation screen is displayed in the display unit 161, the sub-screen display control portion 63 superimposes the sub-screen on the operation screen. The sub-screen display control portion 63 may display the sub-screen instead of the operation screen. In this case, when the sub-screen display control portion 63 ends the display of the sub-screen, the operation screen that is displayed before the sub-screen is displayed may be displayed in the display unit 161.

FIG. 5 is a diagram showing one example of the screen displayed in the display unit. Referring to FIG. 5, a screen 500 includes an operation screen 501 and instruction keys 511 to 515. The operation screen shows an operation screen corresponding to the copying process. The instruction key 511 is associated with the sub-screen of the job list, the instruction key 512 is associated with the sub-screen of the numeric keyboard, the instruction key 513 is associated with the sub-screen for problem notification, the instruction key 514 is associated with the sub-screen for procedure notification, and the instruction key 515 is associated with the sub-screen for consumables.

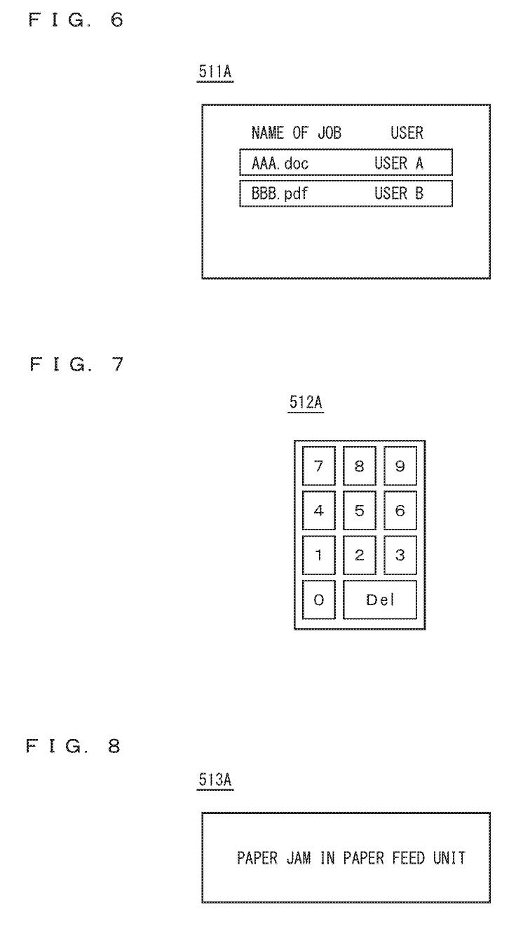

FIG. 6 is a diagram showing one example of the sub-screen of the job list. Referring to FIG. 6, a sub-screen 511A of the job list includes job identification information for respectively identifying the job under execution and the reserved job, and user identification information, which is associated with the job identification information, for identifying the user who has given an instruction to execute the job. In the screen 500 shown in FIG. 5, when the instruction key 511 is designated, the sub-screen 511A of the job list is superimposed on the operation screen 501.

FIG. 7 is a diagram showing one example of the sub-screen of the numeric keyboard. Referring to FIG. 7, a sub-screen 512A of the numeric keyboard includes images of numerals from 0 to 9. In the screen 500 shown in FIG. 5, when the instruction key 512 is designated, the sub-screen 512A of the numeric keyboard is superimposed on the operation screen 501.

FIG. 8 is a diagram showing one example of the sub-screen for problem notification. Referring to FIG. 8, the sub-screen 513A for problem notification includes a message “Paper jam in paper feed unit”. The sub-screen 513A for problem notification corresponds to the copying process for controlling the image forming unit 140 and the paper feed unit 150. In the screen 500 shown in FIG. 5, when the instruction key 513 is designated, the sub-screen 513A for problem notification is superimposed on the operation screen 501.

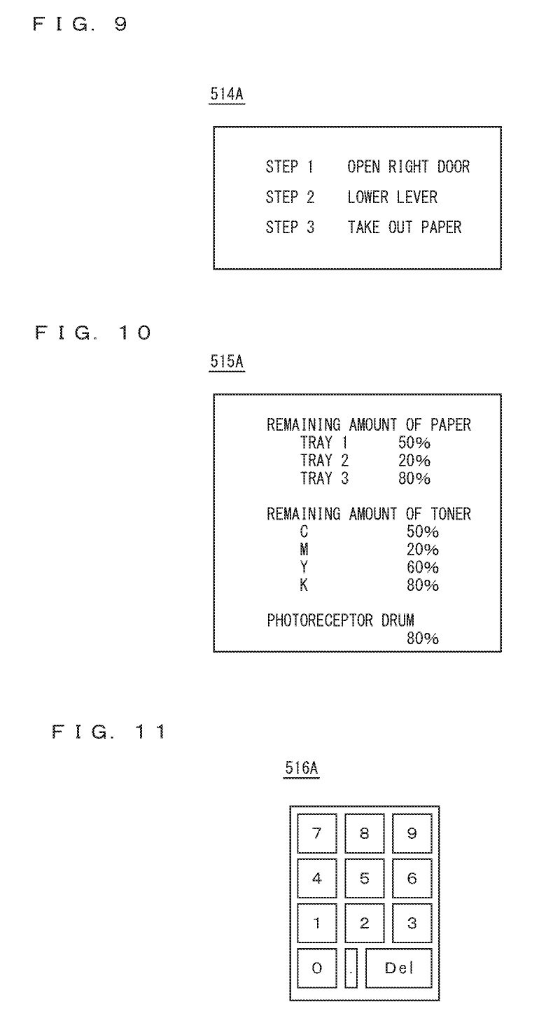

FIG. 9 is a diagram showing one example of the sub-screen for procedure notification. Referring to FIG. 9, a sub-screen 514A for procedure notification includes descriptions of “Step 1: Open right door”, “Step 2: Lower lever”, and “Step 3: Take out paper”. The sub-screen 514A for procedure notification corresponds to the copying process for controlling the image forming unit 140 and the paper feed unit 150. In the screen 500 shown in FIG. 5, when the instruction key 514 is designated, the sub-screen 514A for procedure notification is superimposed on the operation screen 500.

FIG. 10 is a diagram showing one example of the sub-screen for consumables. Referring to FIG. 10, a sub-screen 515A for consumables includes descriptions indicating a remaining amount of the paper, which is a consumable, for each “Tray 1”, “Tray 2”, and “Tray 3”, descriptions indicating a remaining amount of toner, which is a consumable, for each cyan “C”, magenta “M”, yellow “Y”, and black “K”, and a description indicating a ratio of a period of use to a duration period of a photoreceptor drum, which is a consumable. The sub-screen 515A for consumables corresponds to the copying process for controlling the image forming unit 140 and the paper feed unit 150. In the screen 500 shown in FIG. 5, when the instruction key 515 is designated, the sub-screen 515A for consumables is superimposed on the operation screen 501.

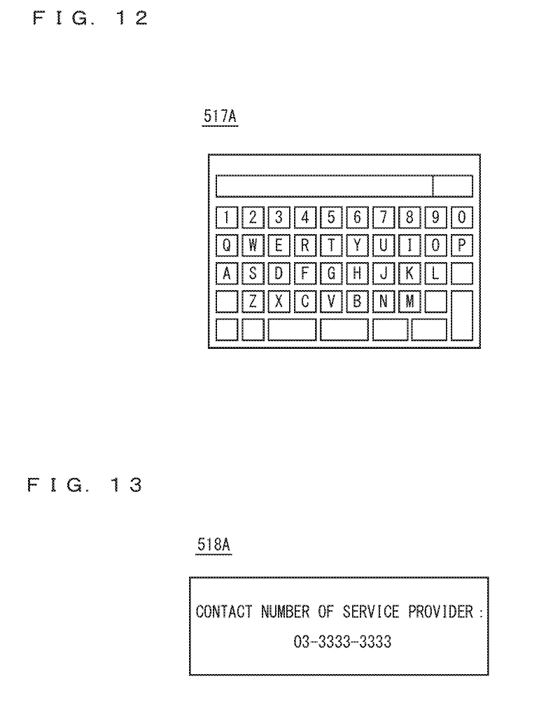

FIG. 11 is a diagram showing one example of the sub-screen of the keyboard with a radix point. Referring to FIG. 11, a sub-screen 516A of the keyboard with a radix point includes images of numerals from 1 to 9, and an image of a radix point “.”.

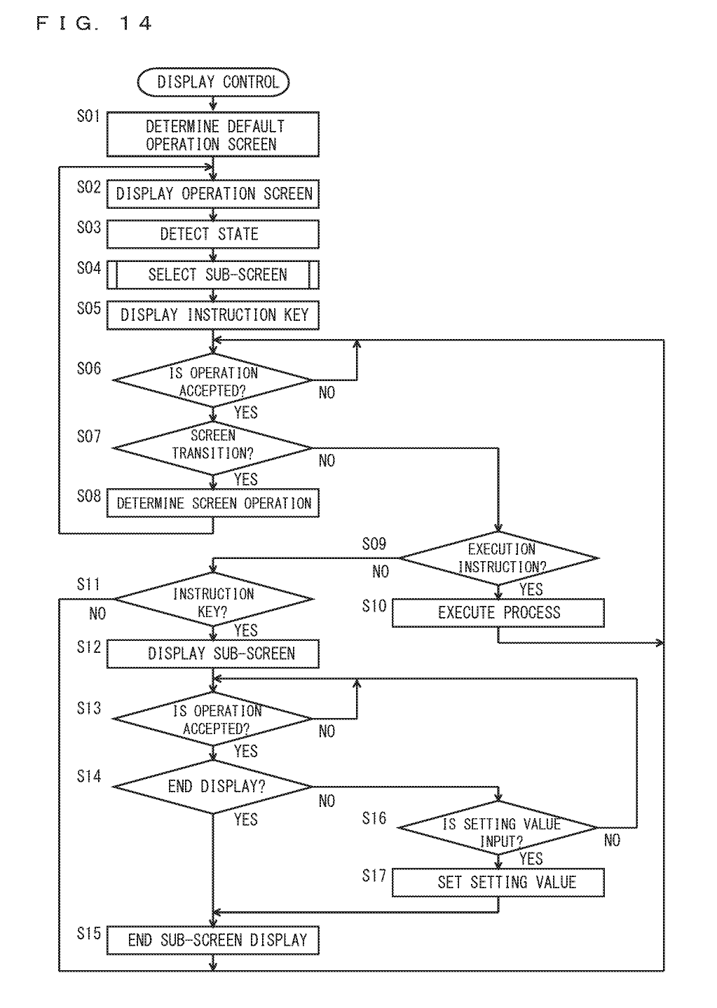

FIG. 12 is a diagram showing one example of the sub-screen of the English-numeric keyboard. Referring to FIG. 12, a sub-screen 517A of the English-numeric keyboard includes images of the alphabet, and images of numerals from 0 to 9.

FIG. 13 is a diagram showing one example of the sub-screen for requesting repair. Referring to FIG. 13, a sub-screen 518A for requesting repair includes a description of “Contact number of service provider: 03-3333-3333”.

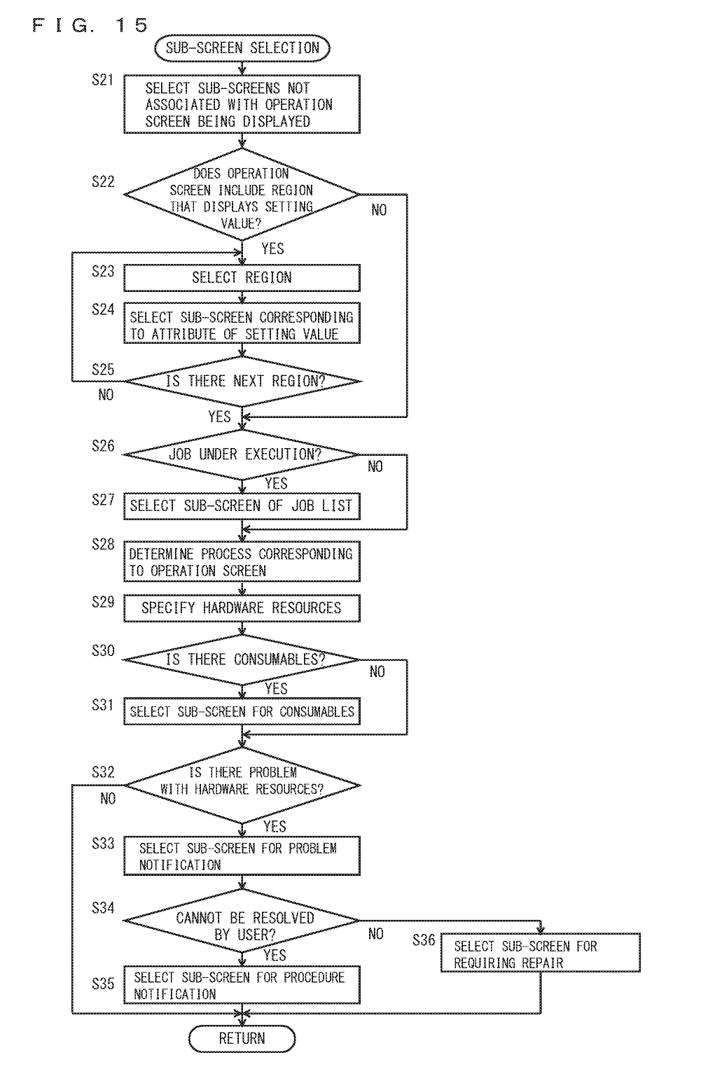

FIG. 14 is a flow chart showing one example of a flow of a display control process. The display control process is processing capacity executed by the CPU 111 when the CPU 111 included the MFP 100 executes a display control program stored in the ROM 113, the HDD 115 or the CD-ROM 118. Referring to FIG. 14, the CPU 111 determines a default operation screen, and the process proceeds to the step S02. The default operation screen is a predetermined operation screen, and is displayed when power is applied to the MFP 100, or when the MFP 100 is recovered from a sleep state where power consumption is low, for example. In the step S02, the determined operation screen is displayed in the display unit 161, and the process proceeds to the step S03. In the case where the process proceeds from the step S01, the default operation screen is displayed. In the case where the process proceeds from the step S08, described below, the operation screen determined in the step S08 is displayed.

In the step S03, the state of the MFP 100 is detected, and the process proceeds to the step S04. The state of the MFP 100 includes a state of the process executed by the MFP 100 and states of the hardware resources of the MFP 100. The state of the process executed by the MFP 100 includes whether the process is under execution by the MFP 100, what the process is if the process is under execution, presence and absence of the process reserved to be executed by the MFP 100 in the future, what the process is if the process is reserved, and a setting value that is set for execution of the process by the MFP 100. The states of the hardware resources of the MFP 100 include presence or absence of a problem with the hardware resources, the description of the problem in the case where there is a problem, and states of consumables of the hardware resources. The states of the consumables include remaining amounts and a ratio of a period of use to a duration period.

In the step S04, a sub-screen selection process is executed, and the process proceeds to the step S05. While details of the sub-screen selection process are described below, the sub-screen selection process is a process of selecting one or more sub-screens from among a plurality of sub-screens based on the operation screen displayed in the step S02 and/or the state of the MFP 100 detected in the step S03.

In the step S05, one or more instruction keys respectively corresponding to one or more selected sub-screens are displayed in the display unit 161, and the process proceeds to the step S06. In the step S06, whether an operation has been accepted is determined. The process waits until an operation by the user is accepted (NO in the step S07). If the operation is accepted, the process proceeds to the step S07. In the step S07, whether the accepted operation is a screen transition operation of making a transition of the screen is determined. For example, in the case where the transition key in the operation screen is designated, the screen transition operation is accepted. If the screen transition operation is accepted, the process proceeds to the step S08. If not, the process proceeds to the step S09. In the step S08, the operation screen specified by the screen transition operation is determined, and the process returns to the step S02. Specifically, the operation screen associated with the transition key designated by the user is determined.

In the step S09, whether the accepted operation is the execution instruction operation of giving an instruction to execute the process is determined. For example, in the case where the start key of the hard keys included in the hard key unit 167 is designated, the execution instruction operation is accepted. If the execution instruction operation is accepted, the process proceeds to the step S10. If not, the process proceeds to the step S11. In the step S10, the process corresponding to the operation screen displayed in the display unit 161 in the step S02 is executed, and the process returns to the step S06.

In the step S11, whether any one of the one or more instruction keys displayed in the display unit 161 in the step S05 is designated is determined. If any one of the one or more instruction keys is designated, the designated instruction key is specified and the process proceeds to the step S12. If not, the process returns to the step S06. In the step S12, the sub-screen corresponding to the instruction key specified in the step S11 is displayed in the display unit 161, and the process proceeds to the step S13. In the step S13, whether an operation corresponding to the displayed sub-screen is accepted is determined. The process waits until the operation corresponding to the sub-screen is accepted (NO in the step S13). If the operation corresponding to the sub-screen is accepted (YES in the step S13), the process proceeds to the step S14.

In the step S14, whether the operation accepted in the step S13 is an operation of giving an instruction to end the display of the sub-screen is determined. In the case where the operation of giving an instruction to end the display of the sub-screen is accepted, the process proceeds to the step S15. If not, the process proceeds to the step S16. In the step S15, the display of the sub-screen is ended, and the process returns to the step S06.

In the step S16, whether the operation accepted in the step S13 is an operation of inputting a setting value is determined. If the operation of inputting the setting value is accepted, the process proceeds to the step S17. If not, the process returns to the step S13. In the step S17, a setting value determined by the operation of inputting a setting value is set, and the process proceeds to the step S15. In the step S15, the display of the sub-screen is ended, and the process returns to the step S06.

FIG. 15 is a flow chart showing one example of a flow of the sub-screen selection process. The sub-screen selection process is a process executed in the step S04 of the display control process. Referring to FIG. 15, the CPU 111 selects sub-screens not associated with the operation screen being displayed (step S21). This is because the sub-screens associated with the operation screen being displayed in the display unit 161 can be displayed by an operation of the operation screen.

In the step S22, whether the operation screen being displayed in the display unit 161 includes a region that displays a setting value is determined. If the operation screen includes the region that displays the setting value, the process proceeds to the step S23. If not, the process proceeds to the step S26. In the step S23, the region that displays the setting value in the operation screen is selected as a target of the process. In the next step S24, a sub-screen corresponding to an attribute of the setting value set in the region selected as the target of the process from among the sub-screens selected in the step S21 is selected. Specifically, in the case where an attribute of the setting value indicates only numerals, the sub-CPU 111 selects the sub-screen of the numeric keyboard. In the case where an attribute of the setting value indicates numerals including a radix point, the sub-CPU 111 selects the key board with a radix point. In the case an attribute of the setting value indicates only English letters, the sub-CPU 111 selects the sub-screen of the English keyboard. In the case where an attribute of the setting value indicates a combination of English letters and numerals, the sub-CPU 111 selects the English-numeric keyboard.

In the next step S25, whether a region that is not selected as the target of the process among regions that display the setting values included in the operation screen is present is determined. If the region that is not selected as the target of the process is present, the process returns to the step S23. If not, the process proceeds to the step S26.

In the step S26, whether the job is under execution is determined. Whether the job under execution is present is determined based on the state detected in the step S03 of the display control process. If the job under execution is present, the process proceeds to the step S27. If not, the process proceeds to the step S28. In the step S27, the sub-screen of the job list is selected, and the process proceeds to the step S28. The sub-screen of the job list includes the job identification information for identifying the job which is the process under execution, and the job identification information for identifying the job which is the process reserved to be executed in the future, and the like.

In the step S28, the process corresponding to the operation screen displayed in the display unit 161 is determined. The process using a setting value that is set in the region that displays the setting value included in the operation screen is determined. In the step S29, the hardware resources corresponding to the determined process are specified. Specifically, the hardware resources that drive when the process determined in the step S28 is executed are specified from among the hardware resources of the MFP 100. The hardware resources include the communication interface (I/F) unit 112, the facsimile unit 116, the HDD 115, the external storage device 117, the automatic document feeder 120, the document scanning unit 130, the image forming unit 140, and the paper feed unit 150.

In the next step S30, whether the specified hardware resources have consumables is determined. If the specified hardware resources have consumables, the process proceeds to the step S31. If not, the process proceeds to the step S32. In the step S31, a sub-screen for consumables that makes notification of the states of the consumables is selected from the sub-screens selected in the step S21, and the process proceeds to the step S32. The states of the consumables include remaining amounts of consumables, and a ratio of a period of use to a duration period of a consumable.

In the step S32, whether there is a problem with the hardware resources specified in the step S29 is determined. If there is a problem, the process proceeds to the step S33. If not, the process returns to the display control process. In the step S33, the sub-screen for problem notification is selected, and the process proceeds to the step S34. The sub-screen for problem notification includes a message indicating a description of the problem or an image indicating the location of the problem. For example, in the case where the operation screen corresponds to the copying process, if there is a problem with the paper feed unit 150 where the paper is jammed, the sub-screen including the message indicating that the paper is jammed and the image indicating the location at which the paper is jammed is selected.

In the step S34, whether the user can resolve the problem detected in the step S32 is determined. Problems that can be resolved by the user and problems that cannot be resolved by the user may be determined in advance. If the problem can be resolved by the user, the process proceeds to the step S35. If not, the process proceeds to the step S36.

In the step S35, the sub-screen for procedure notification is selected, and the process returns to the display control process. The sub-screen for procedure notification includes a description or an image of the procedure for resolving a problem, for example. On the one hand, in the step S36, the sub-screen for requesting repair is selected, and the process returns to the display control process. The sub-screen for requesting repair includes information of the contact number of a repairer.

As described above, the MFP 100 in the present embodiment functions as the image processing apparatus, selects one or more sub-screens from among the plurality of sub-screens not associated with the operation screen displayed in the display unit 161 based on the state of the process under execution and/or the operation screen displayed in the display screen 161, displays the one or more instruction keys respectively associated with the one or more selected sub-screens in the display unit 161 simultaneously with the operation screen, and displays the sub-screen associated with the designated instruction key in response to the designation of any one of the one or more instruction keys by the user. The plurality of operation screens are respectively associated with at least one of the other operation screens, and include a region for accepting the setting value for execution of at least one of the plurality of processes. Therefore, although not being directly associated with the operation screen that is displayed in the display unit 161, the sub-screen related to the operation screen can be displayed. Further, the sub-screen associated with the state of the MFP 100 can be displayed. As a result, a sub-screen different from the operation screen displayed in the display unit 161 can be displayed in the operation screen without association.

Further, because at least one of the sub-screen of the numeric keyboard, the sub-screen of the keyboard with a radix point, the sub-screen of the English keyboard, and the sub-screen of the English-numeric keyboard is selected as the sub-screen for input of the setting value accepted in the operation screen displayed in the display unit 161, the sub-screen that is common among the plurality of operation screens can be displayed without being respectively associated with the plurality of operation screens.

Further, because the sub-screen for notifying the user of the state of the process execution portion 57 is selected as the sub-screen for notifying the user of the state of the process execution portion 57 based on the state of the process execution portion 57, the user can easily perform an operation of displaying the state of the job.

Further, the sub-screen for notifying the user of the state of the process execution portion 57 is a sub-screen for notifying the user of the state associated with the process corresponding to the operation screen displayed in the display unit 161. For example, a sub-screen for confirmation of the setting state that displays the list of one or more setting values that are set for execution of the process associated with the operation screen displayed in the display unit 161 by the process execution portion 57 is included. Therefore, the user can easily perform an operation of making notification of the information associated with the process which the user is allowing the MFP 100 to execute.

Further, the sub-screen for notifying the user of the state of the process execution portion 57 includes a sub-screen of the job list for notifying the user of a process under execution by the process execution portion 57 and a process reserved to be executed. Therefore, the user can easily perform an operation of making notification of the process under execution.

Further, the sub-screen for notifying the user of the state of the process execution portion 57 includes the sub-screen for notifying the user of the states of the hardware resources, and the sub-screen for assisting the user with a problem with the hardware resources. The sub-screen for notifying the user of the states of the hardware resources includes a sub-screen for consumables that makes notification of the states of the consumables of the hardware resources. Therefore, the user can easily perform an operation of making notification of the states of the hardware resources to be used for the process of which the user is allowing execution.

Because the sub-screen for notifying the user of the state of the process execution portion 57 includes the sub-screen for assisting the user with a problem with the hardware resources, an operation of allowing the assistance information associated with the problem to be displayed can be easily performed. In the case where there is a problem that the process associated with the operation screen displayed in the display unit 161 cannot be executed, the sub-screens for assisting the user include the sub-screen for problem notification that makes notification of the problem, and the sub-screen for requesting repair that includes the information of the contact number of the repairer. Therefore, it is possible to easily perform an operation of making notification of the problem that the process associated with the operation screen displayed in the display unit 161 cannot be executed.

While the MFP 100 has been described as one example of the image processing apparatus in the above-mentioned embodiment, the present invention may of course be identified as the display control method for allowing the MFP 100 to execute the display control process shown in FIGS. 14 and 15 or a display control program for allowing the CPU 111 that controls the MFP 100 to execute the display control method.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An image processing apparatus comprising:
a display capable of displaying an image;
a hardware processor capable of executing at least one of a plurality of processes, wherein
the hardware processor
displays any one of a plurality of operation screens, which are respectively associated with at least one of other operation screens and for accepting a setting value for execution of at least one of the plurality of processes, in the display,
selects one or more sub-screens among a plurality of sub-screens not associated with an operation screen displayed in the display based on a state of a process executed by the hardware processor and/or the displayed operation screen,
displays one or more instruction keys respectively associated with the one or more selected sub-screens in the display simultaneously with the operation screen displayed in the display, and
in response to designation of any of the one or more instruction keys displayed in the display by a user, displays a sub-screen associated with the designated instruction key among the one or more selected sub-screens in the display.

2. The image processing apparatus according to claim 1, wherein the hardware processor selects a sub-screen for input of a setting value accepted in the displayed operation screen.

3. The image processing apparatus according to claim 1, wherein the hardware processor selects a sub-screen for notifying the user of a state of a process executed by the hardware processor among the plurality of sub-screens.

4. The image processing apparatus according to claim 3, wherein the hardware processor selects a sub-screen that makes notification of a process being executed by the hardware processor among the plurality of sub-screens.

5. The image processing apparatus according to claim 3, wherein the hardware processor, in the case where there is a problem that the hardware processor cannot execute a process, selects a sub-screen that makes notification of assistance information associated with the problem among the plurality of sub-screens.

6. The image processing apparatus according to claim 1, wherein the plurality of operation screens are respectively associated with any of the plurality of processes, and
the hardware processor selects a sub-screen associated with a process associated with the displayed operation screen among the plurality of sub-screens.

7. The image processing apparatus according to claim 6, wherein
the plurality of sub-screens include a sub-screen for confirmation of a setting state that displays a list of one or more setting values set for execution of a process associated with the displayed operation screen by the hardware processor.

8. The image processing apparatus according to claim 6, wherein
the plurality of sub-screens include, in the case where there is a problem that the hardware processor cannot execute a process associated with the displayed operation screen, a sub-screen for problem notification that makes notification of the problem.

9. A display control method performed by an image processing apparatus that includes
a display capable of displaying an image, and
a hardware processor capable of executing at least one of a plurality of processes, wherein
the display control method causes the hardware processor to execute:
an operation screen display control step of displaying any one of a plurality of operation screens, which are respectively associated with at least one of other operation screens and for accepting a setting value for execution of at least one of the plurality of processes by the hardware processor, in the display;
a sub-screen selection step of selecting one or more sub-screens among a plurality of sub-screens not associated with an operation screen displayed in the display based on a state of a process executed by the hardware processor or the displayed operation screen;
an instruction key display control step of displaying one or more instruction keys respectively associated with the one or more selected sub-screens in the display simultaneously with an operation screen displayed in the display; and
a sub-screen display control step of, in response to designation of any of the one or more instruction keys displayed in the display by a user, displaying a sub-screen associated with the designated instruction key among the one or more selected sub-screens in the display.

10. The display control method according to claim 9, wherein
the sub-screen selection step includes selecting a sub-screen for input of a setting value accepted in the displayed operation screen.

11. The display control method according to claim 9, wherein
the sub-screen selection step includes selecting a sub-screen for notifying the user of the state of the process executed by the hardware processor among the plurality of sub-screens.

12. The display control method according to claim 11, wherein
the sub-screen selection step includes selecting a sub-screen that makes notification of a process being executed by the hardware processor among the plurality of sub-screens.

13. The display control method according to claim 11, wherein
the sub-screen selection step, in the case where there is a problem that the hardware processor cannot execute a process, includes selecting a sub-screen that makes notification of assistance information associated with the problem.

14. The display control method according to claim 9, wherein
the plurality of operation screens are respectively associated with any of the plurality of processes, and
the sub-screen selection step includes selecting a sub-screen associated with a process associated with the displayed operation screen among the plurality of sub-screens.

15. The display control method according to claim 14, wherein
the plurality of sub-screens includes a sub-screen for confirmation of a setting state that displays a list of one or more setting values set for execution of the process associated with the displayed operation screen.

16. The display control method according to claim 14, wherein
the plurality of sub-screens, in the case where there is a problem that the hardware processor cannot execute the process associated with the displayed operation screen, includes a sub-screen for problem notification that makes notification of the problem.

17. A non-transitory computer-readable recording medium encoded with a display control program executed by a computer controlling an image forming apparatus,
the image forming apparatus comprising a display capable of displaying an image, wherein
the display control program causes the computer to execute:
a process execution step of executing at least one of a plurality of processes;
an operation screen display control step of displaying any one of a plurality of operation screens, which are respectively associated with at least one of other operation screens and for accepting a setting value for execution of at least one of the plurality of processes in the process execution step, in the display;
a sub-screen selection step of selecting one or more sub-screens among a plurality of sub-screens not associated with an operation screen displayed in the display based on a state of a process executed in the process execution step or the displayed operation screen;
an instruction key display control step of displaying one or more instruction keys respectively associated with the one or more selected sub-screens in the display simultaneously with an operation screen displayed in the display; and
a sub-screen display control step of, in response to designation of any of the one or more instruction keys displayed in the display by a user, displaying a sub-screen associated with the designated instruction key among the one or more selected sub-screens in the display.
